(19) United States
(12) Patent Application Publication
(10) Pub. No.: US 2012/0257741 A1
(43) Pub. Date: Oct. 11, 2012

(54) TELEPHONE NUMBER INVENTORY MANAGEMENT

(75) Inventors: Bhaskar R. Gudlavenkatasiva, Tampa, FL (US); Sutap Chatterjee, Tampa, FL (US); Nityanand Sharma, Tampa, FL (US); Pradeepan Ravindranathan, Tampa, FL (US)

(73) Assignee: VERIZON PATENT AND LICENSING INC., Basking Ridge, NJ (US)

(21) Appl. No.: 13/083,674

(22) Filed: Apr. 11, 2011

(51) Int. Cl. H04M 3/42

(52) U.S. Cl. 379/218.01

(57) ABSTRACT

Systems and methods may include generating, using keypad letter mapping, a plurality of alphabet strings corresponding to digits of a telephone number; identifying, for one or more of the alphabet strings, a sequence of letters forming at least one term; calculating, using a metric, a value of the at least one term; and storing, in association with the telephone number in a database, the one or more of the alphabet strings for which an associated value exceeds a particular threshold.

### BACKGROUND

Telecommunications service providers often maintain a large inventory of telephone numbers available for assignment to end users. As part of the telephone service ordering system, telephone subscribers may be presented with available telephone numbers from which to choose. Various methodologies may be used for generating a sampling, from the vast inventory, of prospective telephone numbers that can practicably be presented to the subscriber for selection. With respect to 10-digit telephone numbers, the subscriber's location, for example, may prescribe the options available regarding the Numbering Plan “area code” (1^{st} three digits) and/or the Central Office “exchange code” (next three digits).

The ordering system may then use some process by which to determine a limited set of “subscriber numbers” (last four digits) that is to be presented to the subscriber for selection. In practice, however, such winnowing processes typically do not account for the relative desirability of the telephone numbers themselves, from the perspective of subscribers in general and/or the immediate subscriber in particular.

### BRIEF DESCRIPTION OF THE DRAWINGS

FIG. 1 depicts a diagram of an exemplary environment in which systems and methods described herein may be implemented;

FIG. 2 illustrates exemplary components of one or more devices depicted in FIG. 1;

FIG. 3 is an exemplary functional block diagram of components implemented in one or more devices depicted in FIG. 1;

FIG. 4 is a flow chart of exemplary processes according to implementations described herein; and

FIG. 5 is an exemplary database according to implementations described herein.

### DETAILED DESCRIPTION

The following detailed description refers to the accompanying drawings. The same reference numbers in different drawings may identify the same or similar elements. Also, the following detailed description does not limit the invention.

Implementations described herein relate to devices, methods, and/or systems that may be configured to determine quality indicators for telephone numbers, for example, based on mnemonic attributes that are determined using telephone keypad letter mapping. In some implementations, identified words and/or acronyms (“terms”), for letter sequences corresponding to the digits of the telephone numbers, may be scored to determine the respective quality indicators. In some implementations, recognized terms may be defined in a configurable list.

In general, scoring metrics may use one or more objective and/or subjective criteria, such as, term length, the number of terms, term location, term relevance/obscurity, for example, independently and/or in any combination, weighted and/or un-weighted, etc.

Once determined, the quality indicators may be used for facilitating management of telephone number inventory. In some implementations, the quality indicators may be compared to a threshold value for the purpose of conserving storage space in a database storing the terms in association with respective telephone numbers. In other implementations, the quality indicators may be used in searching a database of available telephone numbers. In still other implementations, the quality indicators may be used in establishing a fee schedule for assignment of different ones of the available telephone numbers.

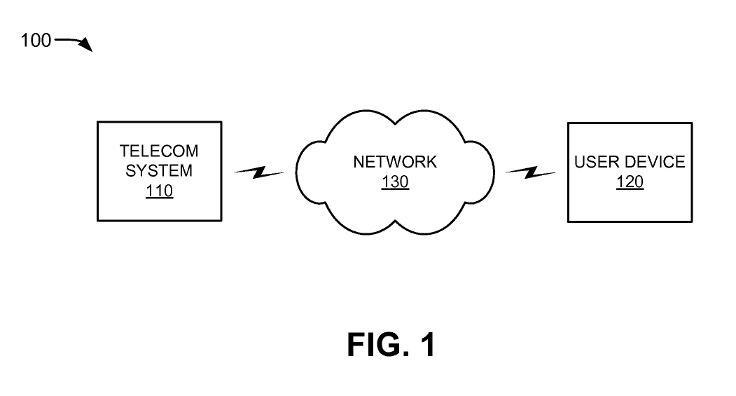

FIG. 1 is a diagram of an exemplary environment 100 in which systems and methods described herein may be implemented. As illustrated, network 100 may include a telecom system 110 and a user device 120 that may interconnect to a network 130, via wired and/or wireless connections, for example, cable, fiber optic, and/or wireless. The number of devices and networks, and configuration in environment 100 is exemplary and provided for simplicity. In practice, environment 100 may include additional devices, fewer devices, different devices, and/or differently arranged devices, than those illustrated in FIG. 1. Additionally, or alternatively, in practice, environment 100 may include additional networks and/or differently arranged networks, than those illustrated in FIG. 1. Also, one or more functions and/or processes described as being performed by a particular device may be performed by a different device, or some combination of devices, according to other embodiments.

Telecom system 110 may include one or more server entities, or other types of computation or communication devices, that gather, process, search, and/or provide information in a manner described herein. In one implementation, telecom system 110 may include a server (e.g., a computer system or an application), a workstation, and/or a service provider capable of providing telecommunication products and/or services. In some implementations, telecom system 110 may be configured to communicate with user device 120 and/or other device (not shown) in the manner described below.

User device 120 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop or notebook computer, a personal computer, an ultra mobile personal computer (UMPC), a netbook, or other types of computation or communication devices, threads or processes running on such devices, and/or objects executable by such devices. In one implementation, user device 120 may include any device (e.g., an Internet Protocol (IP)-based device) that is capable of accessing telecom system 110 via network 130.

Network 130 may include a local area network (LAN), a wide area network (WAN), a metropolitan area network (MAN), a telephone network, such as the Public Switched Telephone Network (PSTN), an intranet, the Internet, an optical fiber (or fiber optic)-based network, or a combination of networks.

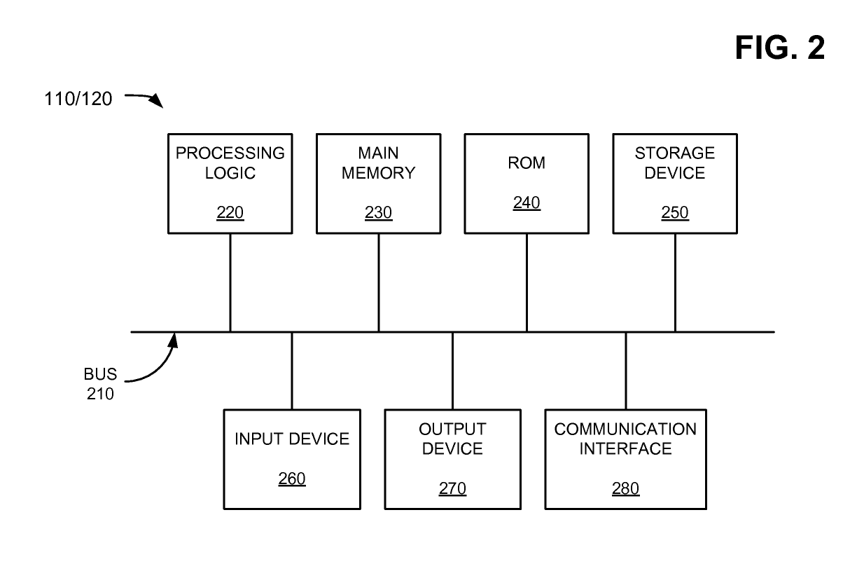

FIG. 2 is an exemplary diagram of a device 200 that may correspond to telecom system 110 and/or user device 120. As illustrated, device 200 may include a bus 210, processing logic 220, a main memory 230, a read-only memory (ROM) 240, a storage device 250, an input device 260, an output device 270, and/or a communication interface 280. Bus 210 may include a path that permits communication among the components of device 200.

Processing logic 220 may include a processor, microprocessor, or other type of processing logic that may interpret and execute instructions. Main memory 230 may include a random access memory (RAM) or another type of dynamic storage device that may store information and instructions for execution by processing logic 220. ROM 240 may include a ROM device or another type of static storage device that may store static information and/or instructions for use by processing logic 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, into telecom system 110 and/or user device 120. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network, such as network 130.

As described herein, device 200 may perform certain operations in response to processing logic 220 executing software instructions contained in a computer-readable medium, such as main memory 230. A computer-readable medium may be defined as a physical or logical memory device. The software instructions may be read into main memory 230 from another computer-readable medium, such as storage device 250, or from another device via communication interface 280. The software instructions contained in main memory 230 may cause processing logic 220 to perform processes described herein. Alternatively, hardwired circuitry may be used in place of or in combination with software instructions to implement processes described herein. Thus, implementations described herein are not limited to any specific combination of hardware devices, circuitry, and/or software.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

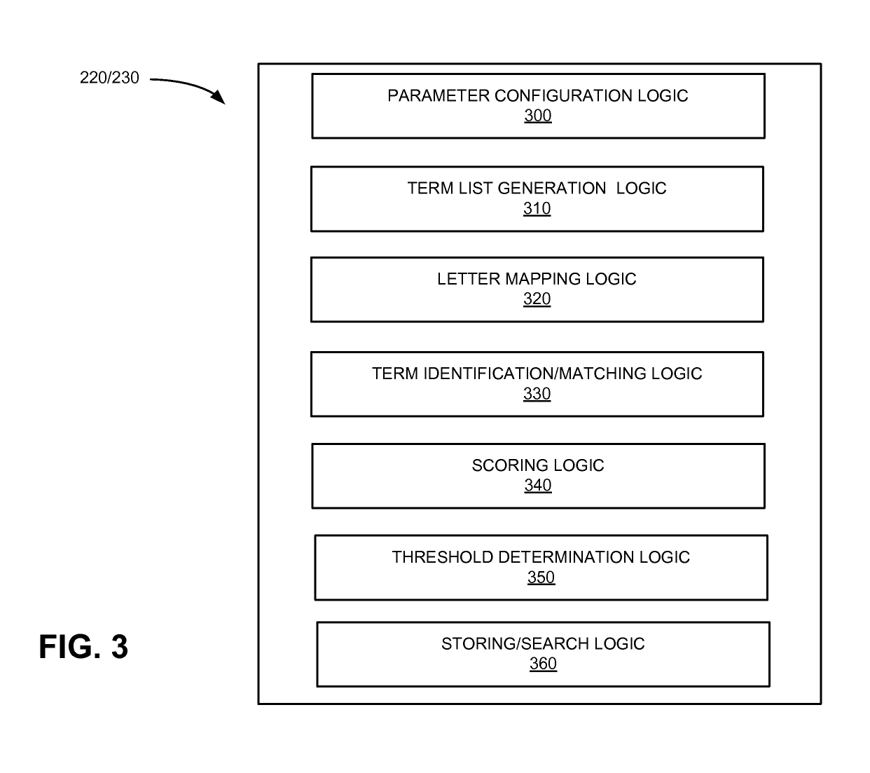

FIG. 3 is an exemplary functional block diagram of components implemented in telecom system 110 and/or user device 120 of FIG. 1. In an exemplary implementation, all or some of the components illustrated in FIG. 3 may be stored in memory 230. For example, referring to FIG. 3, memory 230 may include parameter configuration logic 300, term list generation logic 310, letter mapping logic 320, term identification/matching logic 330, scoring logic 340, threshold determination logic 350, and/or database storing/search logic 360. In addition, various logic components illustrated in FIG. 3 may be implemented by processing logic 220 executing one or more programs stored in memory 230.

Parameter configuration logic 300 may include logic for setting various configuration or initialization data or parameters. In one implementation, parameter configuration logic 300 may be configured to receive user or operator input, via input device 260 and/or communication interface 280, for example, before and/or at any point during processing, providing one or more parameters for system processing, term list generation, such as letter mapping, term identification, term matching, term scoring, threshold determination, database searching, etc., as described in further detail below. Parameter configuration logic 300 may be configured to provide one or more default settings without user input for select parameters.

Term list generation logic 310 may include logic for creating a list of letter and/or numeric sequences to be recognized as “terms.” As used herein, term is intended to be broadly interpreted herein to include, for example, alphabetic and/or alphanumeric sequences of at least two characters (e.g. letters), forming a word, an acronym, an abbreviation (e.g. short message service/texting language), a phrase, a proper noun, etc. Terms may include implied hyphenation, spacing, phonetic and/or alternate spellings, supplied or appended trailing letters, contractions (e.g., implied apostrophes), numerals (e.g., 2, 4, 8, etc.), slang, jargon, and/or any other grammatical variants. In one implementation, term list generation logic 310 may be configured to reference dictionaries and other sources of word lists.

Term list generation logic 310 may generate and/or modify a particular term list based on user-specific information received, for example, from parameter configuration logic 300. In some implementations, term list generation logic 310 may maintain multiple term lists that differ. Term list generation logic 310 may be configured to exclude particular groups of words (e.g., profanity, potentially offensive, etc.) from the list of terms. Consistent with implementations described herein, term list generation logic 310 may be configured to set a minimum length (e.g., 2 characters) and a maximum length (e.g., 10 characters) for terms, based on information received from parameter configuration logic 300. The term list(s) may be stored in a database, for example, in main memory 230 and/or storage device 250.

Letter mapping logic 320 may include logic for converting digits of telephone numbers into a series of alphabet strings using conventional telephone keypad letter mapping, such as, 1=none; 2=A, B, C; 3=D, E, F; 4=G, H, I; 5=J, K, L; 6=M, N, O; 7=P, Q, R, S; 8=T, U, V; 9=W, X, Y, Z; and 0=none. Based on information received from parameter configuration logic 300, for example, the digit-to-letter mapping may be configured in any manner, for example, designating the digit “0” as the letter “O” and the digit “1” as the letter “l,” etc. Letter mapping logic 320 may be configured to generate a partial or an entire series of alphabet strings for a given telephone number. Consistent with embodiments described herein, letter mapping logic 320 may be configured to retain some digits that sound like words (e.g., 2, 4, 8, etc.) as numerals, to generate alphanumeric strings. Letter mapping logic 320 may be configured to adjust the letter mapping used based on user-specific information provided, for example, from parameter configuration logic 310, and/or select or modify a particular letter mapping system based on the user-specific information.

Term identification/matching logic 330 may include logic for identifying terms formed in the alphabet and/or alphanumeric strings provided from letter mapping logic 320 based on a comparison to the list(s) of terms provided from term list generation logic 310. For example, term identification/matching logic 330 may be configured to compare letter sequences (e.g., minimum of 2 letters) contained in the alphabet string to recognized terms. For matching purposes, term identification/matching logic 330 may be configured to treat some numerals (e.g., 2, 4, 8) as words (“to,” “too,”, “for,” “ate,” etc.). In another implementation, term identification/matching logic 330 may provide trailing letters to “complete” a term (that is, create a string that is longer than the telephone number), for example, in dialing plans/systems in which the extra numbers, if dialed, will be ignored. In some implementations, term identification/matching logic 330 and/or letter mapping logic may be configured to re-convert unmatched letters contained in the alphabet strings (and/or alphanumeric strings) back into numerals to create alphanumeric strings. Term identification/matching logic 340 may be configured to identify and/or match particular terms based on user-specific information provided, for example, from parameter configuration logic 310.

Scoring logic 340 may include logic scoring the alphabet strings (and/or alphanumeric strings) based on, for example, information received from term identification/matching logic 330. For example, scoring logic 340 may use one or more scoring metric to score the terms and/or combination of terms identified in the alphabet strings (and/or alphanumeric strings). Consistent with embodiments described herein, information received from parameter configuration logic 300 may be used to select or configure the one or more scoring metrics. In some embodiments, when multiple scoring metrics are used, scoring logic 340 may determine intermediary scores and then a final score based on the intermediary scores. Scoring logic 340 may be configured to adjust scores based on user-specific information provided, for example, from parameter configuration logic 310, and/or select or modify a particular scoring metric based on the user-specific information.

Threshold determination logic 350 may include logic for determining, based on information provided from parameter configuration logic 300, for example, a threshold value for comparing to scores provided from scoring logic 340. Threshold determination logic 350 may be configured to adjust threshold values based on user-specific information provided, for example, from parameter configuration logic 310, and/or select or modify a particular threshold value based on the user-specific information. Consistent with embodiments described herein, results of the comparison of the scores to the threshold value may be used to determine which of the alphabet strings (and/or alphanumeric strings) are and are not to be stored in association with the corresponding telephone numbers. In some embodiments, the results may be used to establish a fee schedule related to assignment of a particular telephone number, for example, as a one-time fee or on a recurring basis, indicative of a relative mnemonic value associated the telephone number.

Storing/search logic 360 may include logic for searching a telephone number inventory based on information, for example, provided from parameter configuration logic 300, term identification/matching logic 330 and/or threshold determination logic 350. Storing/search logic 360 may be configured to adjust searches based on queries and/or user-specific information provided, for example, from parameter configuration logic 310, and/or select or modify a particular search based on the queries and/or user-specific information. In one embodiment, search logic may search for a telephone number(s) that includes a particular search term identified in a query.

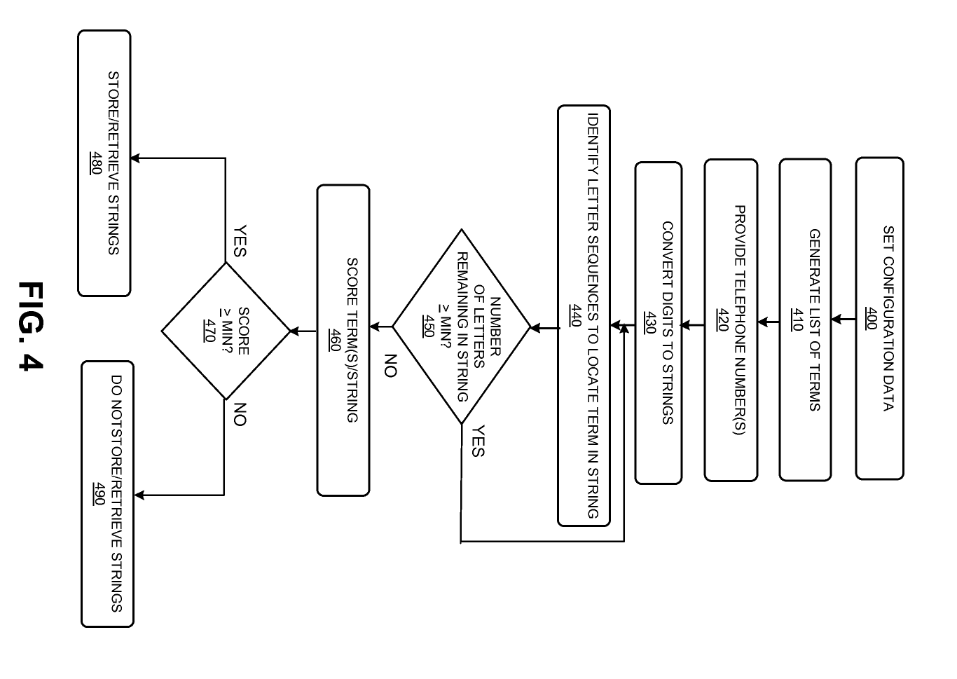

FIG. 4 is a flow diagram illustrating exemplary processing associated with telecom system 110 (FIG. 1). Processing may include parameter configuration logic 300 setting one or more parameters by default and/or based on user/operator input (block 400). For example, letter mapping logic 320 and/or term identification logic 330 may be instructed to treat the numerals, 0 and 1, as the letters, O and L, respectively; to appending trailing letters in order to complete terms; and define minimum and maximum term letter sequences with respect to term length. Other parameters and/or values for such parameters may be configured. Processing may include term generation logic generating a list(s) of terms to include a set(s) of defined terms (block 405). As described above, a particular list of terms may be customized for a particular subscriber, for example, to include terms related to the subscriber.

Next, a particular telephone number or set of telephone numbers are identified for processing (block 410). Telecom system 110 may for example, determine which telephone numbers are “available” (e.g., currently unassigned) and which telephone number are “unavailable” (e.g., currently assigned) for assignment. A telephone number may be identified for processing based on or irrespective of its availability status. In one embodiment, telecom system 100 may group subscriber numbers (“xxxx”) by a particular area code (“NPA”) and/or particular exchange (“NXX”) for processing. For example, letter mapping logic 320 may convert the digits of telephone numbers NPA-XXX-0000 to NPA-XXX-9999 into their respective series of alphabet and/or alphanumeric strings (“strings”) (block 415).

Term identification/matching logic 330 may identify letter sequences, in the strings, to determine letter sequences that fully or at least partially match one or more recognized terms (block 420). Upon locating a term in a string, term identification/matching logic 330 may determine whether the number of letters remaining in the string are less than or greater than a minimum term length (block 425). When the number of letters remaining in the string equal or exceed the minimum length (block 425—YES), term identification/matching logic 330 may identify additional terms in the remaining letters (block 420). When the number of letters remaining in the string are less than the minimum length (block 425—NO), term identification/matching logic 330 may provide the identified term(s) to scoring logic 340 for scoring (block 430).

As discussed above, scoring logic 340 may score the identified terms and the associated respective scores for the strings, using one or more scoring metrics. In one embodiment, scoring may account for the length of (i.e., number of letters in) a term, and the number of terms in a string. For example, a score, V, may be computed according to the following equation:

V=L₁²+L₂²+ . . . +Lₙ² (Eq. 1)

where L is the number of letters in a term, and L² may correspond to a term score or an intermediary score. In this example, with a 2-letter term minimum in place, and a 10-letter term maximum in place, Vₘᵢₙ=4 and Vₘₐₓ=100.

Another example of a metric for computing a score, V, is given by the following equation:

V=(0.5*(1−Dᵤ/10)+0.025*(10−Pₜ+1)+0.025*√(T₁²+T₂²+ . . . Tₙ²))*100 (Eq. 2)

where Dᵤ is the number of unused letters in a string,

where Pₜ is the position of a first letter of a first term in a string, with respect to a left-most letter of the string, and

where T is the number of terms in the string. In this example, with a 10-letter term maximum in place, Vₘₐₓ=100. The above metric generally weights the number of letters used by a factor of 0.5, the position of the first occurring term by a factor of 0.25, and the number of terms by a factor of 0.25. Other weighting is possible.

It will be appreciated that the above scoring metrics may be modified and other scoring models may be used. Consistent with embodiments described herein, letters extending beyond a final letter of a string in order to complete a term (as discussed above), may be counted or discounted for scoring purposes. In one embodiment, when multiple scoring metrics are used, the metrics may have a minimum value, a mid-range value, a maximum value, and/or any other value in common. In some embodiments, scores computed using each metric may include intermediary scores that are combined to calculate an overall score.

In other embodiments, scores computed for respective strings associated with a particular telephone number may include intermediary scores that are combined to calculate an overall score for the particular telephone number. In still other embodiments, any of the above-discussed scores may be used to establish a fee schedule related to telephone number assignment, for example, by imposing fees on subscribers for selecting a telephone number having an associated score within a particular range of scores.

In one embodiment, scores may be compared to a threshold value, for example, by threshold determination logic 350 (block 470). The threshold value may be dynamically adjusted based on a number of criteria, such as user-specific information provided, a state of database storage space, etc.

Consistent with embodiments described herein, results of the comparison of the scores to the threshold value may be used to determine which of the strings are to be stored in a database, in association with the corresponding telephone numbers, in a retrievable state responsive to a search query (block 480); and which of the strings are not to be stored, in association with the corresponding telephone numbers, and thereby unsearchable/irretrievable (block 490). Processing may include searching the telephone number inventory based on a particular string score and/or range of scores, for example, specified in a query received from a user. Search results may be output to the user, with or without presenting the scores, in the form of telephone numbers and/or the corresponding mnemonic terms. In one implementation, the mnemonic terms may be presented as a list, for example, ordered or sorted based on the respective scores and/or ranges of respective scores.

### EXAMPLES

By way of example, assume that the telephone number provided for processing is the 10-digit number, 466-472-4665. Using telephone keypad letter mapping, in which “4” corresponds to “GHI,” “6” corresponds to “MNO,” etc., letter mapping logic 320 (FIG. 3) may convert the digits into the over 78,000 corresponding alphabet strings, beginning with “gmmdpagmmj” and ending with “ioofsciool,” for example. Term identification/matching logic 330 (FIG. 3) may select one or more term lists to use in analyzing the individual alphabet strings to identify the letter sequences that match terms in the selected term list(s). In this example, term identification/matching logic 330 may determine that some of the recognized terms formed in the strings (alphabetic and/or alphanumeric) include, “HOMESCHOOL,” “GOOD-SCHOOL,” “HOODS-2-HOOK,” “HOODS-24665,” “GOODS-24665,” among others, where spacing is implied. In one implementation, term identification/matching logic 330 may be configured to supply trialing letters to form additional terms, such as “HOMESCHOOLING,” and “GOOD-SCHOOLING.”

Scoring logic 340 (FIG. 3) may select one or more scoring metrics to score each of the strings including the identified terms. Assume that the mathematical expression given by Eq. 1 above is used in scoring the strings. For example, HOMESCHOOL, having a term length of 10 letters, yields a score of 100, corresponding to 10²; GOOD-SCHOOL a score of 52 (i.e., 4²+6²); HOODS-24665 a score of 25 (i.e., 5²); GOODS-24665 a score of 25 (i.e., 5²); and so on. In one embodiment, the appending letters in HOMESCHOOLING and GOOD-SCHOOLING (i.e., ING) may be ignored for scoring purposes. In other embodiments, the extra letters may be scored and/or scored differently than the letters corresponding to the digits of the telephone number. In one embodiment, HOODS-2-HOOK may be scored as 41 (5²+4²), and in other embodiments the numeral “2” may be scored as the word “to,” yielding a score of 45 (5²+2²+4²).

Assume now that the mathematical expression given by Eq. 2 above is used in scoring the strings. For example, HOMESCHOOL, having a term length of 10 letters, yields a score of 100, corresponding to (i.e., 0.5*(1−0/10)+0.025*(10−1+1)+0.025*√10²)*100; GOOD-SCHOOL a score of 93 (i.e., 0.5*(1−0/10)+0.025*(10−1+1)+0.025*√(4²+6²))*100); and so on. In one implementation, term identification/matching logic 330 may treat the scores determined using Eq. 1 and the scores determined using Eq. 2 as intermediary scores. In this embodiment, term identification/matching logic 330 may combine the corresponding scores in any manner to determine an overall score. For example, HOMESCHOOL may have an overall score of 100 (i.e., (100+100)/2); GOOD-SCHOOL may have an overall score of 72.5 (i.e., (93+52)/2); and so on. Other methods of computing the overall scores may be used.

Threshold determination logic 350 may determine a threshold to be used in determining which of strings to store in a database in association with the telephone number, 466-472-4665. Assume that a threshold of 40 is determined. Scoring/search logic 360 may compare the above scores to the threshold of 40. Based on the comparison, scoring/search logic 360 may determine that the scores for the strings HOMESCHOOL (100), HOMESCHOOLING (100), GOOD-SCHOOL (52), GOOD-SCHOOLING (52), HOODS-2-HOOK (41 or 45) exceed the threshold (40); and that the scores for the strings HOODS (25) and GOODS (25) are less than the threshold (40).

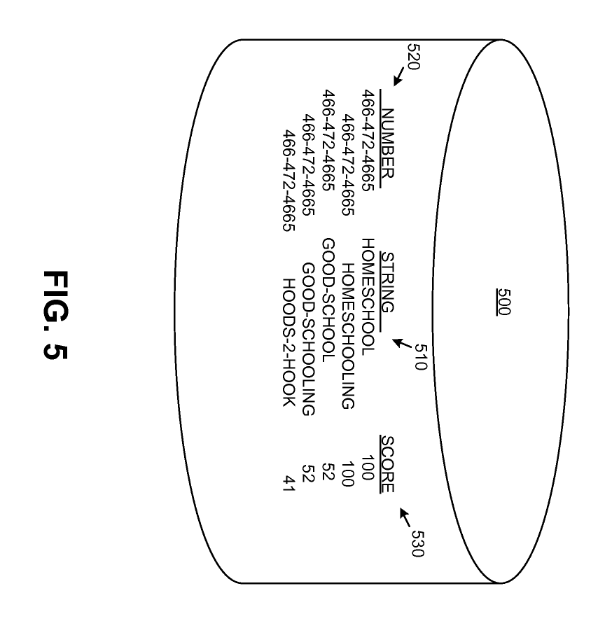

Based on the above results, scoring/search logic 360 may determine to store the strings HOMESCHOOL, HOMESCHOOLING, GOOD-SCHOOL, GOOD-SCHOOLING, and HOODS-2-HOOK in a database; and not to store the strings HOODS and GOODS. FIG. 5 illustrates an exemplary database 500 including the above strings 510 in association with the telephone number 520 and the respective scores 530. Other fields are possible.

Scoring/search logic 360 may perform, responsive to a query, a search of database 500 based on a threshold of 50, for example, determined by threshold determination logic 350 based on the query. Scoring/search logic 360 may return the strings, HOMESCHOOL, HOMESCHOOLING, GOOD-SCHOOL, and GOOD-SCHOOLING based on the search. Assume that user-specific information contained in the query may indicate that the term “good” is particularly relevant to the user. Based on the user-specific information, scoring/search logic 360 may re-arrange an order of the returned strings to list the strings GOOD-SCHOOL and GOOD-SCHOOLING first, even though their scores are lower than the scores for the strings HOMESCHOOL and HOMESCHOOLING. Other modifications may be performed with respect to presentation of the strings based on user-specific or other types of information. In one implementation, scoring/search logic 360 may indicate to the user, a fee associated with allocation of the telephone number, 466-472-4665, based on the one or more of the above scores and/or a combination of one or more of the above scores.

Implementations described herein relate to devices, methods, and systems for using telephone number mnemonics with respect to maintaining a manageable telephone number inventory. In some implementations, a telecom system may include components configured to maintain searchable information regarding telephone number mnemonics with respect to allocating telephone numbers from a telephone number inventory.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

For example, various features have been mainly described above with respect to a telecom system performing telephone number processing and storing functions. In other implementations, features described herein may be implemented mainly in one or more devices remote from the telecom system, or by an individual, workstation, and/or company associated with the telecom system.

Further, while series of blocks have been described with respect to FIG. 4, the order of the acts may be varied in other implementations. Moreover, non-dependent acts may be implemented in parallel.

It will also be apparent that various features described above may be implemented in many different forms of software, firmware, and hardware in the implementations illustrated in the figures. The actual software code or specialized control hardware used to implement the various features is not limiting. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
generating, using keypad letter mapping, a plurality of alphabet strings corresponding to digits of a telephone number;
identifying, for one or more of the alphabet strings, a sequence of letters forming at least one term;
calculating, using a metric, a value of the at least one term; and
storing, in association with the telephone number in a database, ones of the one or more of the alphabet strings for which an associated value exceeds a particular threshold.

2. The method of claim 1, further comprising:
converting letters, other than the sequence of letters, in the one or more of the alphabet strings, back to the corresponding digits of the telephone number to form one or more alphanumeric strings, wherein storing the one or more of the alphabet strings comprises storing the one or more alphanumeric strings.

3. The method of claim 1, wherein the one or more of the alphabet strings comprises at least two of the alphabet strings, the method further comprising:
presenting, to a user in response to a request for telephone number assignment, the at least two of the alphabet strings in an order based on respective values associated with the at least two of the alphabet strings.

4. The method of claim 1, wherein the one or more of the alphabet strings comprises at least two of the alphabet strings, the method further comprising:
obtaining user information related to a user associated with a request for telephone number assignment;
modifying, based on the user information, the values associated with the at least two of the alphabet strings; and
presenting, to the user, the at least two of the alphabet strings in an order based on the modified values associated with the at least two of the alphabet strings.

5. The method of claim 1, wherein the metric comprises determining a square of a number of letters included in the sequence of letters for each of the at least one term.

6. The method of claim 1, wherein the metric comprises multiple metrics, the method further comprising:
calculating, using each of the metrics, an intermediary value of the at least one term, wherein calculating the value is based on the intermediary values.

7. The method of claim 1, wherein storing the one or more of the alphabet strings comprises storing one or more of the alphabet strings in a database associated with a telephone number inventory, and the value represents a quality indicator of the first telephone number relative to other telephone numbers in the telephone number inventory.

8. The method of claim 1, wherein identifying a sequence of letters comprises:
appending, to the one or more of the alphabet strings, at least one trailing letter to form the at least one term, wherein the at least one trailing letter has no corresponding digit in the telephone number.

9. The method of claim 1, further comprising:
determining a particular fee, associated with assignment of the telephone number to the subscriber, based on the calculated value.

10. A method comprising:
storing, in a database, terms formed by letter sequences in alphabet strings mapped to digits of a plurality of telephone numbers in a telephone number inventory;
scoring the terms; and
searching, based on the scoring and in association with an order for assignment of a telephone number, the telephone number inventory database to produce a subset of the plurality of telephone numbers.

11. The method of claim 10, wherein scoring the terms comprises using a metric to calculate values indicative of relative mnemonic quality.

12. The method of claim 10, wherein scoring the terms comprises using a metric to customize the scoring of the terms, for a particular user associated with the order, based on information related to the user.

13. The method of claim 10, wherein the order is received via a network, the method further comprising:
presenting, to a user device via the network, one or more telephone numbers of the subset of telephone numbers; and
receiving, from the user device via the network, a selection of at least one telephone number of the subset of telephone numbers.

14. The method of claim 10, further comprising:
determining, based on the scoring, a fee schedule associated with assignment of ones of the plurality of telephone numbers.

15. A system comprising:
one or more processors configured to:
provide a list of terms;
generate, using keypad letter mapping, a plurality of alphabet strings corresponding to digits of a plurality of telephone numbers,
match, to the list of terms, letter sequences for one or more of the alphabet strings,
calculate, in association with the one or more of the alphabet strings, values corresponding to the letter sequences, and
compare the values to a configurable threshold; and
a database configured to store, in association with the plurality of telephone numbers, a subset of the one or more of the alphabet strings for which the associated values exceed the configurable threshold.

16. The system of claim 15, wherein the one or more processors are further configured to modify the configurable threshold based on a number of the alphabet strings in the subset of the one or more of the alphabet strings.

17. The system of claim 15, further comprising:
a communication interface configured to:
receive a query identifying a particular term, wherein the one or more processors are further configured to perform a search, of the subset of the one or more of the alphabet strings, for the particular term; and
output results of the search.

18. The system of claim 15, further comprising:
a communication interface configured to:
receive a query related to telephone number assignment, wherein the query includes information related to a particular user; and
the one or more processors being further configured to:
generate, based on the information, a subset of the subset of the one or more of the alphabet strings, and
perform, responsive to the query, a search of the subset of the subset of the one or more of the alphabet strings, wherein the communication interface is further configured to output results of the search.

19. The system of claim 15, further comprising:
a communication interface to receive user input related to a telephone number assignment request, wherein the one or more processors are further configured to modify, based on the user input, at least one of:
the list of words and acronyms,
the plurality of telephone numbers,
the values corresponding to the letter sequences, or
the configurable threshold.

20. The system of claim 19, wherein the database is further configured to store user information related to the telephone number assignment request, and the one or more processors are further configured to modify, based on the user information, at least one of:
the list of words and acronyms,
the plurality of telephone numbers,
the values corresponding to the letter sequences, or
the configurable threshold.
